(19) United States
(12) Patent Application Publication
(10) Pub. No.: US 2024/0271366 A1
(43) Pub. Date: Aug. 15, 2024

(54) Composite Body

(71) Applicant: SEIKO EPSON CORPORATION, Tokyo (JP)

(72) Inventors: Tomoyuki USHIYAMA, Chino (JP); Xianmei LIU, Nagano (JP)

(21) Appl. No.: 18/437,581

(22) Filed: Feb. 9, 2024

(30) Foreign Application Priority Data
Feb. 10, 2023 (JP) 2023-019254

(51) Int. Cl. D21H 17/00; B24D 11/00; D21H 17/06; D21H 17/18; D21H 17/28; D21H 21/14; D21H 27/00

(52) U.S. Cl. CPC D21H 17/72; B24D 11/00; D21H 17/06; D21H 17/18; D21H 17/28; D21H 21/14; D21H 27/00

(57) ABSTRACT

A composite body includes starch composite particles containing starch, a plasticizer, and a crosslinking agent, and fibers, the starch composite particles being dispersed between the fibers.

The present application is based on, and claims priority from JP Application Serial Number 2023-019254, filed Feb. 10, 2023, the disclosure of which is hereby incorporated by reference herein in its entirety.

### BACKGROUND

### 1. Technical Field

The present disclosure relates to a composite body.

### 2. Related Art

In recent years, products using as little petroleum-derived raw materials as possible have been required, and for example, an attempt has been made to use plant-derived raw materials. In such situation, examination is performed to replace a paper strengthening agent added to paper or the like, which contains cellulose as a main component, by a naturally-derived component. For example, JP-T-2021-155655 discloses a structure using fibers, a thermoplasticizer, and starch, and thus, not using a petroleum-derived raw material.

However, starch plasticized by the thermoplasticizer has high moisture absorption. Therefore, for example, when a structure is placed in an environment at high humidity, the structure may be deformed due to a decrease in mechanical strength of the plasticized starch. That is, the structure using the starch plasticized by the thermoplasticizer is required to have moisture resistance in addition to mechanical strength.

### SUMMARY

According to an aspect of the present disclosure, a composite body contains starch composite particles, which contain starch, a plasticizer, and a crosslinking agent, and fibers, the starch composite particles being dispersed in the fibers.

According to an aspect of the present disclosure, a composite body contains starch composite particles, which contain starch and a plasticizer, a crosslinking agent, and fibers, the starch composite particles being dispersed in the fibers.

### BRIEF DESCRIPTION OF THE DRAWINGS

FIG. 1 is a conceptual view of starch composite particles dispersed between fibers.

FIG. 2 is a drawing schematically showing an example of a composite body producing apparatus according to an embodiment.

FIG. 3 is a table (Table 1) showing the compositions, combinations, and evaluation results of examples.

FIG. 4 is a table (Table 2) showing the compositions, combinations, and evaluation results of examples.

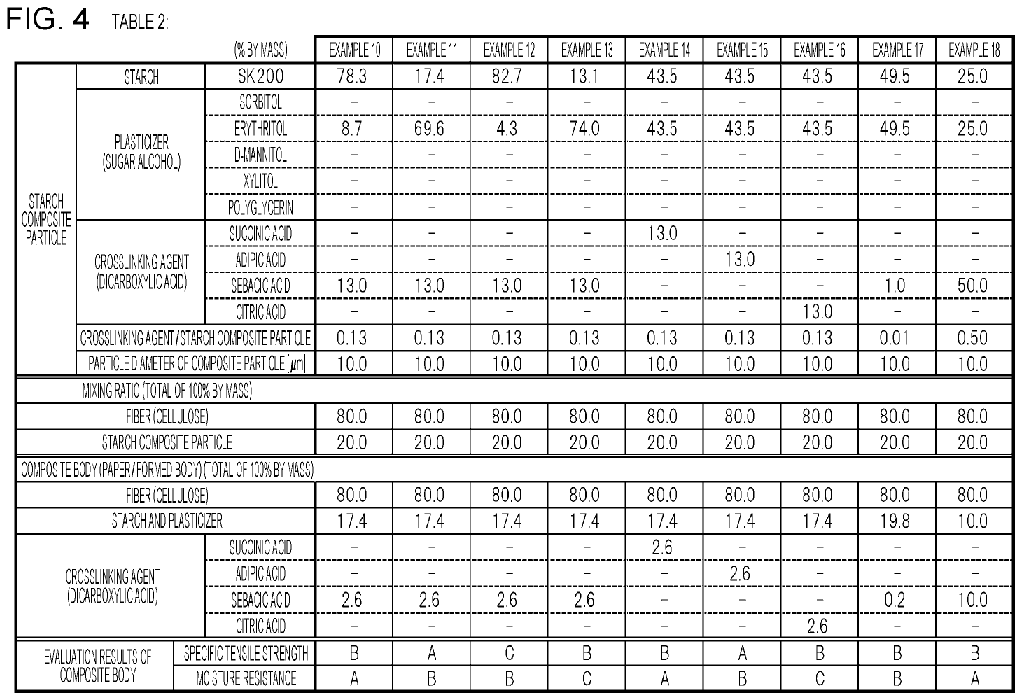

FIG. 5 is a table (Table 3) showing the compositions, combinations, and evaluation results of examples and comparative examples.

FIG. 6 is a table (Table 4) showing the compositions, combinations, and evaluation results of examples.

FIG. 7 is a table (Table 5) showing the compositions, combinations, and evaluation results of examples.

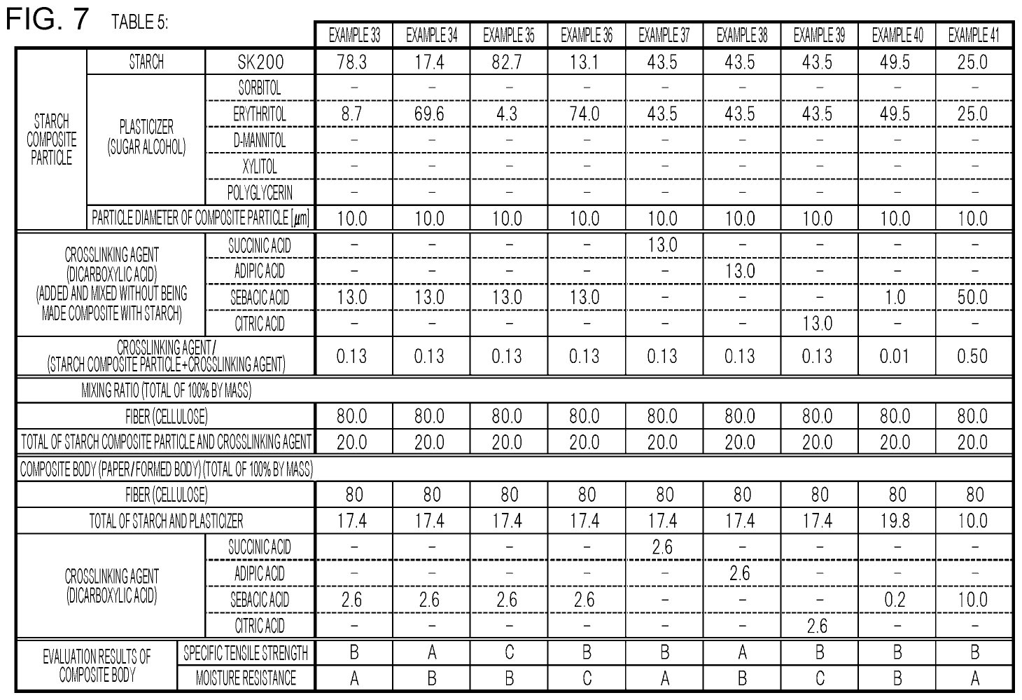

FIG. 8 is a table (Table 6) showing the compositions, combinations, and evaluation results of examples and comparative examples.

### DESCRIPTION OF EMBODIMENTS

An embodiment of the present disclosure is described below. The embodiment described below describes an example of the present disclosure. The present disclosure is not particularly limited to the embodiment below and includes various modified embodiments carried out within a range not changing the gist of the present disclosure. All configurations described below are not necessarily essential components of the present disclosure.

### 1. First Embodiment

A composite body according to the present embodiment contains starch composite particles, which contain starch, a plasticizer, and a crosslinking agent, and fibers, the starch composite particles being dispersed in the fibers.

### 1. 1. Starch Composite Particles

The starch composite particles of the embodiment contain the starch, the plasticizer, and the crosslinking agent.

### 1. 1. 1. Starch

The starch is a molecule containing a plurality of α-glucose molecules polymerized through glucoside bonds. The starch may be a linear molecule or may have a branch. For example, various plant-derived starches can be used as the starch. More specific usable examples thereof include starches derived from grains such as corn, wheat, rice, and the like; beans such as fava bean, green bean, red bean, and the like; potatoes such as potato, sweet potato, tapioca, and the like; wildflowers such as bracken, kudzu, and the like; and palms such as sago palm and the like.

The starch may be modified starch. Examples of the modified starch include acetylated adipic acid-crosslinked starch, acetylated starch, oxidized starch, starch sodium octenyl succinate, hydroxypropyl starch, hydroxypropylated phosphoric acid-crosslinked starch, phosphorylated starch, phosphate-esterified phosphoric acid-crosslinked starch, urea phosphorylated esterified starch, sodium starch glycolate, high-amylose corn starch, and the like. In addition, dextrin produced by processing or modifying starch may be used as modified starch.

The weight-average molecular weight of the starch is not particularly limited, but is preferably 50,000 or more and 400,000 or less, more preferably 70,000 or more and 300,000 or less, and still more preferably 80,000 or more and 280,000 or less. With the molecular weight within this range, mixing of the starch and the plasticizer can be more improved. Thus, even when water is absent or present in only a small amount, plasticization by heating is allowed to easily proceed, and thus strength and productivity of the composite body can be more improved.

The weight-average molecular weight of the starch can be determined by gel permeation chromatography measurement. The weight-average molecular weight described in examples described later is also a value determined by gel permeation chromatography measurement.

### 1. 1. 2. Plasticizer

The starch composite particles contain the plasticizer. The plasticizer has the property of plasticizing the starch. When the starch is plasticized by the plasticizer, the starch exhibits thermoplasticity. In the present specification, the starch plasticized as described above may be referred to as the “thermoplastic starch” or “plasticized starch”.

The plasticizer is, for example, a sugar alcohol. The plasticizer is preferably one or more selected from sugar alcohols. When the plasticizer is selected from sugar alcohols, the starch can be more easily plasticized. This easily causes binding of the fibers to each other by the starch composite particles and thus can impart better strength to the composite body.

The sugar alcohol is a type of sugar produced by reduction of a carbonyl group of aldose or ketose. Examples of the sugar alcohol include maltitol, lactitol, tetritol, pentitol, hexitol, erythritol, sorbitol, xylitol, and mannitol. Among these, one or more selected from sorbitol, erythritol, and D-mannitol are more preferred.

Sorbitol, erythritol, or D-mannitol among sugar alcohols can facilitate plasticization of the starch, but does not cause plasticization at room temperature, thereby facilitating handling in the production process and handling of the produced composite body. Therefore, the fibers are more easily bound to each other by the starch composite particles, and better strength can be generated in the composite body.

On the other hand, polyglycerin may also be used as the plasticizer. The polyglycerin is produced by polymerizing glycerol, and the polymerization degree is not particularly limited. Further, a compound containing many hydroxyl groups is considered to have the property of plasticizing starch, and such a compound may also be used as the plasticizer.

The plasticizer has a content more suitable for starch. When the total content of the plasticizer and the starch is 100% by mass. The content [% by mass] of the plasticizer is preferably 5% by mass or more and 90% by mass or less, more preferably 10% by mass or more and 85% by mass or less, and still more preferably 10% by mass or more and 80% by mass or less. When the plasticizer is contained within the range described above relative to the starch, the starch is more sufficiently plasticized, and thus better strength can be imparted to the composite body.

### 1. 1. 3. Crosslinking Agent

The starch composite particles according to the embodiment contain the crosslinking agent. The crosslinking agent reacts, by heating, with the hydroxyl groups contained in the starch, the plasticizer, and the fibers. The crosslinking agent is an organic compound having two or more carboxyl groups.

The crosslinking agent is not particularly limited as long as it is an organic compound having plural carboxyl groups. Examples of the crosslinking agent include aliphatic dicarboxylic acids such as oxalic acid, malonic acid, succinic acid, glutaric acid, adipic acid, pimelic acid, suberic acid, azelaic acid, sebacic acid, and the like; aromatic dicarboxylic acids such as phthalic acid, isophthalic acid, terephthalic acid, and the like;

dicarboxylic acids having hydroxyl group, such as tartaric acid, malic acid, and the like; tricarboxylic acids such as citric acid, aconitic acid, and the like; amino acids having plural carboxyl groups, such as aspartic acid, glutamic acid, and the like; and a mixture of these.

In view of mainly reactivity with hydroxyl groups, the crosslinking agent is preferably one or more selected from dicarboxylic acids. Such a dicarboxylic acid can form an ester bond with a hydroxyl group possessed by each of the fibers, the starch, and the plasticizer, and thus the fibers and the starch, the fibers, and the starch and the starch can be chemically crosslinked. The ester bond (chemical bond) can be confirmed by FTIR.

Further, the crosslinking agent is more preferably one or more selected from succinic acid, adipic acid, and sebacic acid, among dicarboxylic acids. The crosslinking agent forms chemical crosslinks by ester bonds between the fibers and the starch, between the fibers, and between the starch and the starch, and thus the strength and moisture resistance of the composite body can be more improved.

The content [% by mass] of the crosslinking agent in the starch composite particles is preferably 1% by mass or more and 60% by mass or less, more preferably 1% by mass or more and 50% by mass or less, still more preferably 5% by mass or more and 20% by mass or less, and even still more preferably 10% by mass or more and 20% by mass or less.

With such a content of the crosslinking agent, the degree of chemical crosslinking between the fibers and starch, between the fibers, and between the starch and the starch is more improved, and thus the moisture resistance and strength of the composite body can be made excellent.

### 1. 1. 4. Production of Starch Composite Particles

The starch composite particles according to the embodiment are formed by, for example, a spray drying method. The spray drying method is not particularly limited, and a known method can be used. However, the starch composite particles according to the embodiment contain the plasticizer and the crosslinking agent, and thus spray drying is preferably performed by applying as little heat as possible.

The spray drying method is performed by mixing the starch, the plasticizer, and the crosslinking agent in water and, if required, applying heat, thereby preparing a gelatinized liquid. The temperature of heating is preferably 100° C. or less, more preferably 98° C. or less, and still more preferably 95° C. or less. In preparing the gelatinized liquid, when the crosslinking agent has low water solubility, the gelatinized liquid may be prepared by mixing the starch and the plasticizer in water and, if required, applying heat, then the gelatinized liquid is mixed with a solution separately prepared by dissolving the crosslinking agent in a proper water-soluble organic solvent, such as ethanol or the like, and used for the spray drying method.

When the starch composite particles according to the embodiment are formed by the spray drying method, the size and shape of the resultant starch composite particles can be controlled by properly adjusting the supply rate of the gelatinized liquid (mixed liquid), the inlet temperature, the outlet temperature, the retention time, the number of atomizer rotations, the atomizing pressure, etc.

In the spray drying method, the temperature (inlet temperature) of the inlet in which the solution is introduced in a spray drying device is preferably 100° C. or more and 200° C. or less, more preferably 110° C. or more and 190° C. or less, and still more preferably 120° C. or more and 180° C. or less. The temperature (outlet temperature) of the outlet from which the solution is discharged by spraying is preferably 40° C. or more and 100° C. or less, more preferably 50° C. or more and 90° C. or less, and still more preferably 60° C. or more and 80° C. or less.

The spray drying apparatus is not particularly limited, and, for example, ADL311S-A manufactured by Yamato Scientific Co., Ltd. can be used.

The average particle diameter [μm] of the granulated starch composite particles is preferably 1 μm or more and 60 μm or less, more preferably 1 μm or more and 50 μm or less, still more preferably 2 μm or more and 30 μm or less, and even still more preferably 2 μm or more and 20 μm or less. The starch composite particles having an average particle diameter within the range described above easily exhibit a more uniform dispersion state of the starch composite particles between the fibers in the composite body, and thus the moisture resistance and strength of the composite body can be made more excellent.

The average particle diameter of the starch composite particles can be measured by, for example, a particle size distribution analyzer using a laser diffraction/scattering method as a measurement principle. The particle size distribution analyzer is, for example, a particle size distribution meter (for example, “Microtrac MT3000II” manufactured by Nikkiso Co., Ltd.) using a dynamic light scattering method as a measurement principle.

### 1. 2. Fibers

The fibers are not particularly limited, and a wide range of fiber materials can be used. Examples of the fibers include natural fibers (animal fibers and plant fibers), chemical fibers (organic fibers, inorganic fibers, and organic-inorganic composite body fibers), and the like. In further detail, examples thereof include fibers composed of cellulose, silk, wool, cotton, hemp, kenaf, flax, ramie, jute, Manila hemp, sisal hemp, softwood, hardwood, and the like. These may be used alone, used as a proper mixture, or used as regenerated fibers after purification.

Examples of the raw material of the fibers include used paper, used cloth, and the like, and the raw material may contain at least one type of the fibers described above. Also, the fibers may be subjected to various surface treatments. The material of the fibers may be a pure material or a material containing a plurality of components such as impurities, additives, and other components.

Among these, the fibers containing cellulose are more preferred. The cellulose contains many hydroxyl groups in the molecular structure thereof. Therefore, the cellulose easily reacts with the crosslinking agent and thus easily improves the moisture resistance and mechanical strength of the composite body.

The length of the fibers is not particularly limited, but the length along the longitudinal direction of the fibers is preferably 1 μm or more and 5 mm or less, more preferably 2 μm or more and 3 mm or less, and still more preferably 3 μm or more and 2 mm or less.

### 1. 3. Formation of Composite Body

The composite body is formed by mixing the starch composite particles and the fibers and then applying heat to the resultant mixture. The starch composite particles have thermoplasticity and also have reactivity caused by the crosslinking agent. Therefore, the fibers are physically bound to each other by heating the mixture. Also, when the mixture is heated, the hydroxyl groups present in the fibers, the starch, and the plasticizer react with the crosslinking agent and are chemically bonded to each other.

The mixing ratio of the fibers and the starch composite particles in the composite body can be properly determined according to the application and required performance of the composite body. For example, when the mixing ratio of the fibers and the starch composite particles is represented by the total content [% by mass] of the starch, the plasticizer, and the crosslinking agent in the composite body, the mixing ratio is preferably 1% by mass or more and 90% by mass or less, more preferably 1.5% by mass or more and 85% by mass or less, still more preferably 1.5% by mass or more and 80% by mass or less, and even still more preferably 5% by mass or more and 80% by mass or less. When the mixing ratio of the fibers and the starch composite particles in the composite body is within the range described above, satisfactory strength can be obtained.

1. 4. Dispersion of Starch Composite Particles in Composite Body

In the composite body according to the embodiment, the starch composite particles are dispersed in the fibers described above. The dispersed state represents a state where the starch composite particles are scattered between the fibers. As described above, the composite body is formed by heating. Therefore, the starch composite particles in the composite body are present in a solidified state after being plasticized.

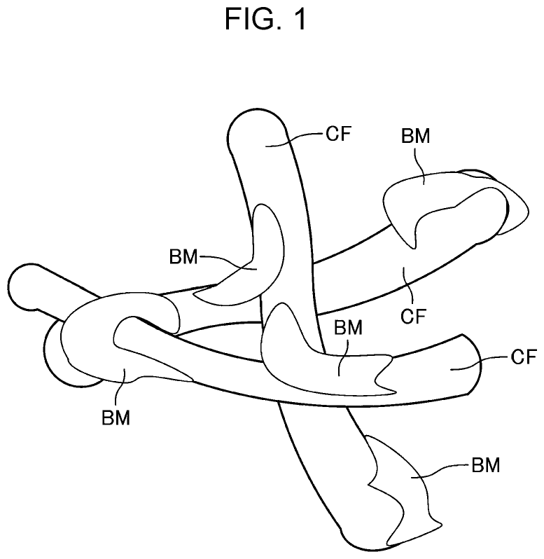

FIG. 1 is a conceptual view of the starch composite particles dispersed between the fibers. As shown in FIG. 1, starch composite particles BM in the composite body lose their particle shape of before melting and are present in the state of being fixed to stick to cellulose fibers CF. In this state, a plurality of fibers CF are physically bound to each other, and chemical bonds are also formed by the crosslinking agent, thereby fixing a positional relation between the fibers CF. That is, the binding property between the fibers CF is in a satisfactory state. The mutual positional relation between the fibers CF in the composite body is fixed or little moved due to binding, and thus the outer shape of the composite body is moderately fixed and maintained, thereby allowing the composite body to maintain the shape of, for example, a buffer, a sheet, or the like.

In addition, the fibers CF of the composite body may have an unbound portion, which can be adjusted by the amount of the starch composite particles mixed. The larger the amount of the unbound portion in the fibers CF is, the more easily deformation can be caused. On the other hand, binding of a larger amount of the fibers CF in the composite body decreases flexibility but increases shape maintenance and mechanical strength.

### 1. 5. Application of Composite Body

As described above, the composite body can be obtained by heat forming. Therefore, the composite body can be formed into various shapes. The composite body can be formed into a two-dimensional shape such as a sheet shape, a board shape, a web shape, or the like; a three-dimensional shape such as a block shape, a rod shape, a spherical shape, or the like; or the like. Typical examples of the composite body include paper, a nonwoven fabric, wallpaper, wrapping paper, colored paper, drawing paper, a fiber board, a filter, a liquid absorber, a sound absorber, a buffer, a mat, and the like.

The composite body of the embodiment has excellent moisture resistance and mechanical strength and is thus particularly excellent as a buffer.

### 1. 6. Production of Composite Body

The composite body of the embodiment can be produced by, for example, a production apparatus described below. A composite body producing apparatus includes a mixing portion which mixes a plurality of cellulose fibers and starch composite particles for binding the cellulose fibers, an accumulation portion which accumulate the mixture of the plurality of cellulose fibers and the starch composite particles, and a heating portion which heats the accumulated material accumulated in the accumulation portion, forming the composite body.

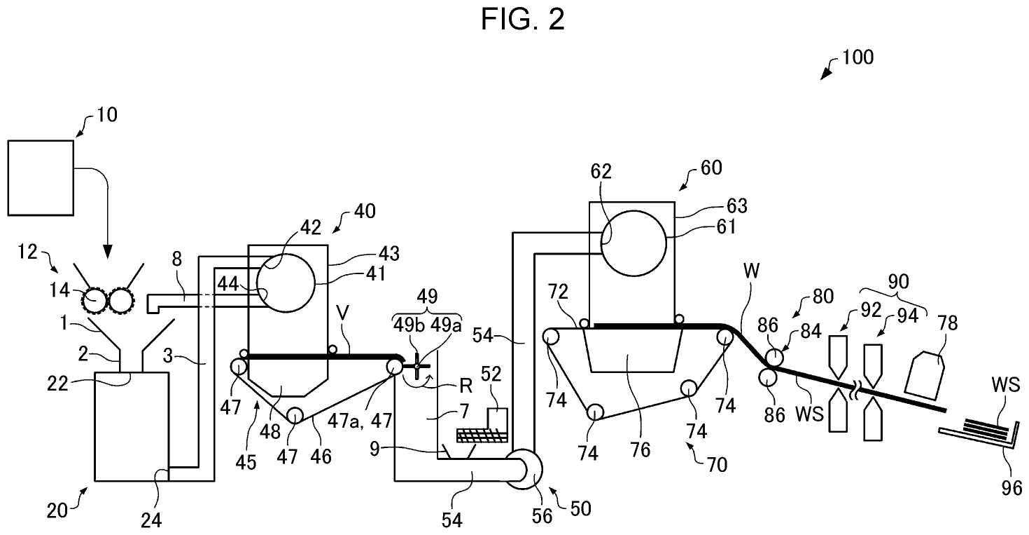

FIG. 2 is a drawing schematically showing a composite body producing apparatus 100. As shown in FIG. 2, the composite body producing apparatus 100 includes a supply portion 10, a crushing portion 12, a defibration portion 20, a sorting portion 40, a first web forming portion 45, a rotor 49, a mixing portion 50, an accumulation portion 60, a second web forming portion 70, a composite body forming portion 80, a cutting portion 90, and a humidifying portion 78.

The supply portion 10 supplies raw materials to the crushing portion 12. The supply portion 10 is, for example. an automatic input portion for continuously supplying the raw materials to the crushing portion 12. The raw materials supplied to the crushing portion 12 may contain cellulose fibers.

The crushing portion 12 cuts into small pieces the raw materials supplied by the supply portion 10 in an atmosphere such as atmospheric air (air) or the like. With respect to the shape and size of the small pieces, for example, the small pieces are several-cm square small pieces. In the example shown in the drawing, the crushing portion 12 has a crushing blade 14 which can cut the raw materials supplied. For example, a shredder is used as the crushing portion 12. The raw materials cut by the crushing portion 12 are received by a hopper 1 and then transferred (transported) to the defibration portion 20 through a pipe 2.

The defibration portion 20 defibrates the raw materials cut by the crushing portion 12. The term “defibrate” represents that a raw material (material to be defibrated) containing a plurality of bound cellulose fibers is disentangled into individual cellulose fibers. The defibration portion 20 also has the function of separating materials adhered to the raw material, such as resin particles, an ink, a toner, a filler, an anti-bleeding agent, etc., from the cellulose fibers.

The material passed through the defibration portion 20 is referred to as the “defibrated material”. The defibrated material may contain, in addition to the disentangled defibrated material cellulose fibers, the resin (the resin for binding a plurality of cellulose fibers together), coloring agents such as an ink, a toner, a filler, and the like, and additives such as an anti-bleeding agent, a paper strengthening agent, and the like, which are separated from the cellulose fibers when the cellulose fibers are disentangled.

The defibration portion 20 performs dry-type defibration. The “dry type” represents that treatment such as defibration is performed in an atmosphere such as atmospheric air or the like, but not in a liquid such as water or the like (a wet type using a slurry prepared by dissolving the material). In the present embodiment, an impeller mill is used as the defibration portion 20. The defibration portion 20 has the function of generating such an airflow that the raw materials are sucked and the defibrated material is discharged. Therefore, the defibration portion 20 can, by the airflow generated by itself, suck the raw materials from the inlet 22 together with the airflow, defibrate the raw materials, and transport the defibrated material to the outlet 24. The defibrated material passed through the defibration portion 20 is transferred to the sorting portion 40 through a pipe 3. The airflow used for transporting the defibrated material from the defibration portion 20 to the sorting portion 40 may be the airflow generated by the defibration portion 20, or an airflow generated by an airflow generator provided therein, such as a blower or the like, may be used.

The sorting portion 40 introduces, from an inlet 42, the defibrated material defibrated by the defibration portion 20 and sorts the material according to the lengths of cellulose fibers. The sorting porting portion 40 has a drum portion 41 and a housing portion 43 which houses the drum portion 41. For example, a sieve is used as the drum portion 41. The drum portion 41 has a net (filter or screen) so as to make it possible to device between the cellulose fibers or particles (passed through the net, a first sorted material) smaller than the opening size of the net and the cellulose fibers, undefibrated pieces, and clumps (not passed through the net, a second sorted material) larger than the opening size of the net. For example, the first sorted material is transferred to the mixing portion 50 through a pipe 7. The second sorted material is returned to the defibration portion 20 from the outlet 44 through a pipe 8. Specifically, the drum portion 41 is a cylindrical sieve rotationally driven by a motor. Examples of the net used for the drum portion 41 include a wire net, an expand metal formed by expanding a metal plate having cuts, a punching metal having holes formed in a metal plate using a press machine or the like.

The first web forming portion 45 transports the first sorted material passed through the sorting portion 40 to the mixing portion 50. The first web forming portion 45 includes a mesh belt 46, stretching rollers 47, and a suction portion (suction mechanism) 48.

The suction portion 48 can suck, onto the mesh belt 46, the first sorted material which is passed through the opening (net opening) of the sorting portion 40 and is disperse in air. The first sorted material is accumulated on the moving mesh belt 46 to form a web V. The basic configuration including the mesh belt 46, the stretching rollers 47, and the suction portion 48 is the same as that of the second web forming portion 70 including a mesh belt 72, stretching rollers 74, and a suction mechanism 76 described later.

The web V is formed in the state of containing a large amount of air and being softly expanded by passing through the sorting portion 40 and the first web forming portion 45. The web V accumulated on the mesh belt 46 is supplied to the pipe 7 and transported to the mixing portion 50.

The rotor 49 can cut the web V before the web V is transported to the mixing portion 50. In the example shown in the drawing, the rotor 49 has a base portion 49a and projecting portions 49b projecting from the base portion 49a. The projecting portions 49b have, for example, a plate-like shape. The example shown in the drawing is provided with the four projecting portions 49b, and the four projecting portions 49b are provided at equal intervals. The projecting portions 49b can be rotated around the base portion 49a as the axis by rotating the base portion 49a in the direction R. Cutting the web V by the rotor 49 can decrease, for example, variation in the amount of the defibrated material supplied to the accumulation portion 60 per unit time.

The rotor 49 is provided near the first web forming portion 45. In the example shown in the drawing, the rotor 49 is provided near (at the side of the stretching rollers 47a) the stretching rollers 47a located downstream in the path of the web V. The rotor 49 is provided at the position where the projecting portions 49b can come into contact with the web V and does not come into contact with the mesh belt 46 on which the web V is accumulated. The shortest distance between the projecting portions 49b and the mesh belt 46 is, for example, 0.05 mm or more and 0.5 mm or less.

The mixing portion 50 mixes the first sorted material (the first sorted material transported by the first web forming portion 45) passed through the sorting portion 40 with the additive containing the starch composite particles. The mixing portion 50 has an additive supply portion 52 which supplies the additive, a pipe 54 which transports the first sorted material and the additive, and a blower 56. In the example shown in the drawing, the additive is supplied to the pipe 54 from the additive supply portion 52 through a hopper 9. The pipe 54 is continued to the pipe 7.

The mixing portion 50 generates an airflow by the blower 56 so that in the pipe 54, the first sorted material and the additive can be transported while being mixed together. The mechanism of mixing the first sorted material and the additive is not particularly limited and may use stirring by a high-speed rotating blade or use rotation of a vessel like in a V-type mixer.

A screw feeder shown in FIG. 2 or a disc feeder not shown can be used as the additive supply portion 52. The additive supplied from the additive supply portion 52 contains the starch composite particles BM described above. At the time when the starch composite particles BM are supplied, a plurality of cellulose fibers are not bound. The starch composite particles BM are plasticized and crosslinked when passed through the composite body forming portion 80, thereby binding the plurality of cellulose fibers of the composite body WS.

In addition, the additive supplied from the additive supply portion 52 may contain, other than the starch composite particles BM, a coloring agent for coloring the cellulose fibers, an aggregation inhibitor for suppressing aggregation of the cellulose fibers and aggregation of the starch composite particles BM, and a flame retardant for flameproofing the cellulose fibers and the like according to the type of the composite body WS produced. The mixture (mixture of the first sorted material and the additive) passed through the mixing portion 50 is transferred to the accumulation portion 60 through the pipe 54.

The accumulation portion 60 introduces, from the inlet 62, the mixture passed through the mixing portion 50, and the entangled defibrated material (cellulose fibers) are disentangled and allowed to fall while being dispersed in air. Consequently, in the accumulation portion 60, the mixture can be uniformly accumulated in the second web forming portion 70.

The accumulation portion 60 has a drum portion 61 and a housing portion 63 which houses the drum portico 61, and a rotating cylindrical sieve is used as the drum portion 61. The drum portion 61 has a net so as to cause falling of the cellulose fibers or particles (passed through the net) smaller than the opening size of the net and contained in the mixture passed through the mixing portion 50. The configuration of the drum portion 61 is, for example, the same as the configuration of the drum portion 41.

In addition, the sieve of the drum portion 61 may not have the function of sorting a specific object. That is, the “sieve” used as the drum portion 61 represents including a net, and the mixture introduced into the drum portion 61 may be entirely allowed to fall by the drum portion 61.

The second web forming portion 70 forms a web W including the accumulated material constituting the composite body WS, by accumulating the passed material passed through the accumulation portion 60. The second web forming portion 70 has, for example, a mesh belt 72, stretching rollers 74, and a suction mechanism 76.

The mesh belt 72 accumulates, while moving, the passed material passed through the opening (net opening) of the accumulation portion 60. The mesh belt 72 is stretched by the stretching roller 74 and thus is configured to hardly pass the passed material and to pass the air. The mesh belt 72 is moved by rotation of the stretching rollers 74. The passed material passed through the accumulation portion 60 is continuously allowed to fall and pile up while the mesh belt 72 is continuously moved, thereby forming the web W on the mesh belt 72. The mesh belt 72 is, for example, made of a metal, made of a resin, made of a fabric, made of a nonwoven fabric, or the like.

The suction mechanism 76 is provided below (opposite to the side of the accumulation portion 60) the mesh belt 72. The suction mechanism 76 can generate a downward airflow (airflow toward the mesh belt 72 from the accumulation portion 60). The suction mechanism 76 can suck the mixture, which is dispersed in air by the accumulation portion 60, on the mesh belt 72. This can increase the discharge rate from the accumulation portion 60. Further, the suction mechanism 76 can form a down flow in the falling path of the mixture, and thus can suppress entanglement of the defibrated material and the additive during falling.

As described above, the web W in the state of containing a large amount of air and being softly expanded can be formed by passing through the accumulation portion 60 and the second web forming portion 70 (web forming process). The web W accumulated on the mesh belt 72 is transported to the composite body forming portion 80. The thickness of the web W (accumulated material) transported to the composite body forming portion 80 is not particularly limited.

The composite body forming portion 80 forms the composite body WS by heating the web W accumulated on the mesh belt 72. In the composite body forming portion 80, plasticization of the starch composite particles BM and crosslinking reaction can be caused by heating the accumulated material (the web W) of the mixture of the defibrated material and the additive mixed in the web W. Then, the plurality of cellulose fibers are physically and chemically bound by the starch composite particles BM.

The composite body forming portion 80 is provided with a heating portion 84 which heats the web W. For example, a heat press or a heating roller (heater roller) is used as the heating portion 84, but an example using the heating roller (heater roller) is described below. The number of the heating rollers in the heating portion 84 is not particularly limited. The example shown in the drawing includes the heating portion 84 having a pair of heating rollers 86. The heating portion 84 configured by the heating rollers 86 can form the composite body WS while continuously transporting the web W. For example, the heating rollers 86 are disposed so that the rotational axes are parallel to each other.

The heating rollers 86 are in contact with the web W and heat the web W while transporting the web W held therebetween. The heating rollers 86 transport the web W held therebetween and form the composite body WS having a predetermined thickness. In this case, the pressure applied to the web W by the heating rollers 86 can be adjusted according to the composite body WS to be produced.

The surface temperature of the heating rollers 86 which heat the web w is properly determined according to the plasticization temperature of the starch composite particles BM and the reaction temperature of the crosslinking agent, but is, for example, 60.0° C. or more and 250.0° C. or less, preferably 70.0° C. or more and 220.0° C. or less, and more preferably 80.0° C. or more and 200.0° C. or less. The heating rollers 86 having a surface temperature within the range described above can heat the web W (accumulated material) within the temperature range described above.

The composite body producing apparatus 100 described above can produce the composite body WS of the embodiment as described above.

If required, the composite body producing apparatus 100 may include a cutting portion 90. In the example shown in the drawing, the cutting portion 90 is provided downstream the heating portion 84. The cutting portion 90 cuts the composite body WS formed by the composite body forming portion 80. In the example shown in the drawing, the cutting portion 90 has a first cutting portion 92 which cuts the composite body WS in the direction crossing the transport direction of the composite body WS and a second cutting portion 94 which cuts the composite body WS in the direction parallel to the transport direction. For example. the second cutting portion 94 cuts the composite body WS passed through the first cutting portion 92.

Also, the composite body producing apparatus 100 of the embodiment may include a humidifying portion 78. In the example shown in the drawing, the humidifying portion 78 is provided downstream the cutting portion 90 and upstream the discharge portion 96. The humidifying portion 78 can add water and water vapor to the composite body WS. Examples of the specific configuration of the humidifying portion 78 include a configuration in which mist of water or an aqueous solution is sprayed, a configuration in which water or an aqueous solution is sprayed, a configuration in which water or an aqueous solution is ejected and adhered from an ink jet heat, and the like.

The composite body producing apparatus 100 including the humidifying portion 78 can bring moisture into the formed composite body WS. This makes the cellulose fibers damp and soft. Therefore, when a vessel or the like is three-dimensionally formed by using the composite body WS, wrinkles or breaks more hardly occur. In addition, the composite body WS is made damp, and thus hydrogen bonds can be easily formed between the cellulose fibers, thereby enhancing the density of the formed vessel or the like and, for example, enabling to improve strength.

In addition, plasticization of the starch composite particles and crosslinking reaction occur by heat, and thus the composite body can be formed by a dry method. Thus, the humidifying portion 78 is not necessarily required for the composite body producing apparatus 100. However, the humidifying portion may be disposed at a proper position in expectation of formation of hydrogen bonds between the fibers.

The composite body WS is formed as described above. The resultant composite body WS is cut by, for example, the cutting portion 90, and if required, the composite body WS is discharged to the discharge portion 96. Also, the composite body WS may be wound into the form of a roll without being cut.

The example described above shows an example in which a sheet-like composite body WS is produced, but it can be understood that a composite body having a three-dimensional shape can be formed by changing the heating portion, the accumulation portion, etc.

### 2. Second Embodiment

A composite body according to the present embodiment contains starch composite particles containing starch and a plasticizer, a crosslinking agent, and fibers, the starch composite particles being dispersed in the fibers. The difference from the first embodiment is that the starch composite particles do not contain the crosslinking agent, and the crosslinking agent is added and mixed with the fibers separately from the starch composite particles.

The starch, the plasticizer, the crosslinking agent, and the fibers used for the composite body of the present embodiment are the same as in the first embodiment described above, and thus description thereof is omitted.

### 2. 1. Production of Starch Composite Particles

The starch composite particles according to the embodiment are formed by, for example, a spray drying method. The spray drying method is not particularly limited, and a known method can be used. However, the starch composite particles according to the embodiment contain the plasticizer, and thus spray drying is preferably performed by applying as little heat as possible.

The spray drying method is performed by mixing the starch and the plasticizer in water and, if required, applying heat to the mixture, thereby preparing a gelatinized liquid.

In the spray drying method, the temperature (inlet temperature) of the inlet in which the solution is introduced in a spray drying device is preferably 100° C. or more and 200° C. or less, more preferably 110° C. or more and 190° C. or less, and still more preferably 120° C. or more and 180° C. or less. In the spray drying method, the temperature (outlet temperature) of the outlet from which the solution is discharged by spraying is preferably 40° C. or more and 100° C. or less, more preferably 50° C. or more and 90° C. or less, and still more preferably 60° C. or more and 80° C. or less.

The average particle diameter [μm] of the granulated starch composite particles is preferably 1 μm or more and 60 μm or less, more preferably 1 μm or more and 50 μm or less, still more preferably 2 μm or more and 30 μm or less, and even still more preferably 2 μm or more and 20 μm or less. The starch composite particles having an average particle diameter within the range described above easily exhibit a more uniform dispersion state of the starch composite particles between the fibers in the composite body, and thus the moisture resistance and strength of the composite body can be made more excellent.

### 2. 2. Formation of Composite Body

The composite body of the embodiment is formed by mixing the starch composite particles, the crosslinking agent, and the fibers and then applying heat to the mixture. The starch composite particles have thermoplasticity. The crosslinking agent also reacts with the hydroxyl groups of the starch, the plasticizer, and the fibers when heat is applied. Therefore, the fibers are physically bound to each other by heating the mixture. Also, when the mixture is heated, the hydroxyl groups present in the fibers, the starch, and the plasticizer react with the crosslinking agent and are chemically bonded to each other.

The mixing ratio of the fibers, the starch composite particles, and the crosslinking agent in the composite body can be properly determined according to the application and required performance of the composite body. For example, when the mixing ratio of the fibers, the starch composite particles, and the crosslinking agent is represented by the total content [% by mass] of the starch, the plasticizer, and the crosslinking agent in the composite body, the mixing ratio is preferably 1% by mass or more and 90% by mass or less, more preferably 1.5% by mass or more and 85% by mass or less, still more preferably 1.5% by mass or more and 80% by mass or less, and even still more preferably 5% by mass or more and 50% by mass or less. When the mixing ratio of the fibers and the starch composite particles in the composite body is within the range described above, satisfactory strength can be obtained.

### 2. 3. Dispersion of Starch Composite Particles in Composite Body

In the composite body according to the embodiment, the starch composite particles are dispersed in the fibers described above. The dispersed state represents a state where the starch composite particles are scattered between the fibers. As described above, the composite body is formed by heating. Therefore, the starch composite particles in the composite body are present in a solidified state after plasticized.

As shown in FIG. 1 described above, also in the composite body of the present embodiment, starch composite particles BM lose their particle shape of before melting and are present in the state of being fixed to stick to cellulose fibers CF. In this state, a plurality of fibers CF are physically bound to each other, and chemical bonds are also formed by the crosslinking agent, thereby fixing a positional relation between the fibers CF. That is, the binding property between the fibers CF is in a satisfactory state. The mutual positional relation between the fibers in the composite body is fixed or little moved due to binding, and thus the outer shape of the composite body is moderately fixed and maintained, thereby enabling the composite body to maintain the shape of, for example, a buffer, a sheet, or the like.

In addition, the fibers CF of the composite body may have an unbound portion, which can be adjusted by the amount of the starch composite particles mixed. The larger the amount of the unbound portion in the fibers CF is, the more easily deformation can be caused. On the other hand, binding of a larger amount of the fibers CF in the composite body decreases flexibility but increases the shape maintenance and mechanical strength.

### 2. 4. Application of Composite Body

Also, application of the composite body of the present embodiment is the same as the first embodiment, and thus description thereof is omitted. Also, the composite body of the embodiment has excellent moisture resistance and mechanical strength and is thus particularly excellent as a buffer.

### 2. 5. Production of Composite Body

The composite body of the embodiment can be produced by, for example, the composite body producing apparatus 100 described above. Specifically, when the crosslinking agent is powdery, the starch composite particles BM and the crosslinking agent may be supplied from the additive supply portion 52. While when the crosslinking agent is liquid, a sprayer or the like is provided at any desired position before the crosslinking agent reaches the heating portion 84 so that the composite body can be formed by spraying the crosslinking agent to the fibers.

### 3. Function and Effect

In both composite bodies of the first embodiment and the second embodiment, the plurality of fibers are bound by the starch imparted with thermoplasticity by the plasticizer, and the crosslinking agent forms chemical crosslinking structures between the fibers and the starch, between the fibers, and between the starch and the starch. Therefore, the composite body has excellent moisture resistance and strength.

### 4. Examples and Comparative Examples

The present disclosure is described in further detail below by giving examples and comparative examples, but the present disclosure is not limited to the examples below.

### 4. 1. Production of Starch Composite Particles

Starch composite particles of examples and comparative examples were produced as described below.

### 4. 1. 1. Starch Composite Particles Containing Starch, Plasticizer, and Crosslinking Agent

The starch composite particles corresponding to the first embodiment, in which the crosslinking agent was succinic acid or citric acid, were produced as described below.

Mixed were 4.5% by mass of oxidized starch (manufactured by Nihon Cornstarch Corporation, SK200), 4.5% by mass of erythritol (manufactured by Tokyo Chemical Industry Co., Ltd.), 1% by mass of succinic acid (manufactured by Fujifilm Wako Pure Chemical Corporation), and water, and the resultant mixture was heated and stirred at 100° C. for 2 hours, preparing a gelatinized starch liquid. The gelatinized starch liquid was sprayed and dried by using a spray drying device (manufactured by Yamato Scientific Co., Ltd., ADL311S-A) at an inlet temperature of 150° C. and an outlet temperature of 70° C., producing starch composite particles of each of the examples.

### 4. 1. 2. Starch Composite Particles Containing Starch, Plasticizer, and Crosslinking Agent

The starch composite particles corresponding to the first embodiment, in which the crosslinking agent was adipic acid or sebacic acid, were produced as described below.

Mixed were 9% by mass of oxidized starch (manufactured by Nihon Cornstarch Corporation, SK200), 9% by mass of erythritol (manufactured by Tokyo Chemical Industry Co., Ltd.), and water, and the resultant mixture was heated and stirred at 100° C. for 2 hours, preparing a gelatinized starch liquid.

Separately, 2% by mass of adipic acid or sebacic acid (manufactured by Tokyo Chemical Industry Co., Ltd.) was mixed with ethanol (manufactured by Tokyo Chemical Industry Co., Ltd.), preparing an adipic acid ethanol solution or a sebacic acid ethanol solution.

Then, the gelatinized starch liquid and the adipic acid ethanol solution or the sebacic acid ethanol solution were mixed at a mass ratio of 1:1.

The resultant mixture was sprayed and dried by using a spray drying device (manufactured by Yamato Scientific Co., Ltd., ADL311S-A) at an inlet temperature of 150° C. and an outlet temperature of 70° C., producing starch composite particles of each of the examples. The starch composite particles of Comparative Example 3 were produced by the same method as described above, except not using the plasticizer.

### 4. 1. 3. Starch Composite Particles Containing Starch and Plasticizer

The starch composite particles corresponding to the second embodiment were produced as described below.

Mixed were 5% by mass of oxidized starch (manufactured by Nihon Cornstarch Corporation, SK200), 5% by mass of erythritol (manufactured by Tokyo Chemical Industry

Co., Ltd.), and water, and the resultant mixture was heated and stirred at 100° C. for 2 hours, preparing a gelatinized starch liquid. Then, the gelatinized starch liquid was sprayed and dried by using a spray drying device (manufactured by Yamato Scientific Co., Ltd., ADL311S-A) at an inlet temperature of 150° C. and an outlet temperature of 70° C., producing starch composite particles (thermoplastic starch) of each of the examples. The particles of Comparative Example 1 were produced by the same method as described above, except not using the plasticizer.

### 4. 1. 4. Composition of Starch Composite Particles

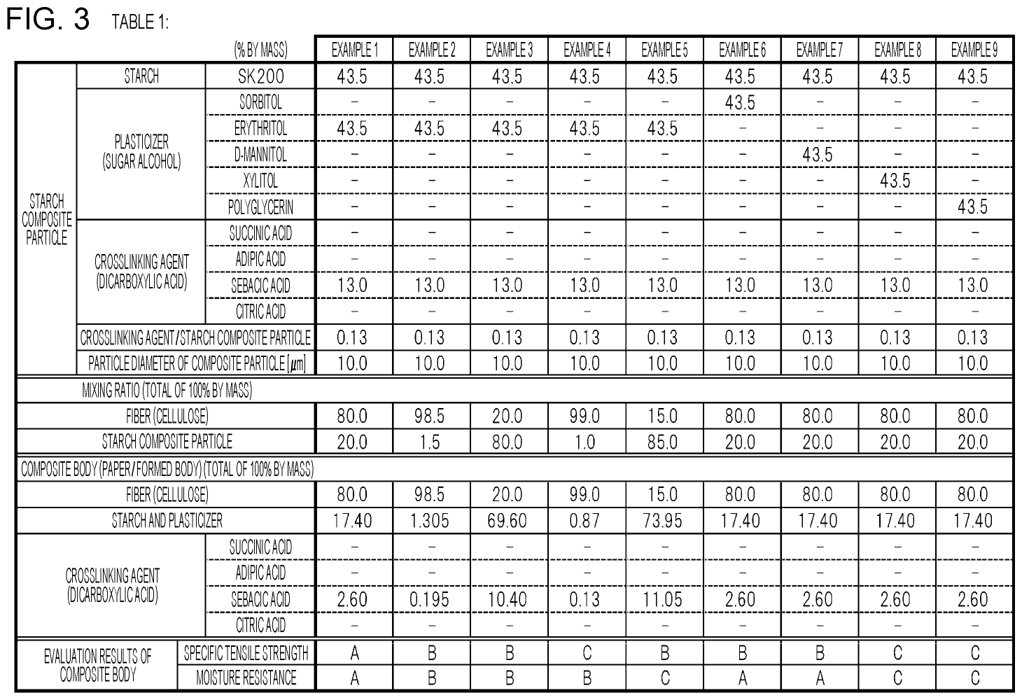

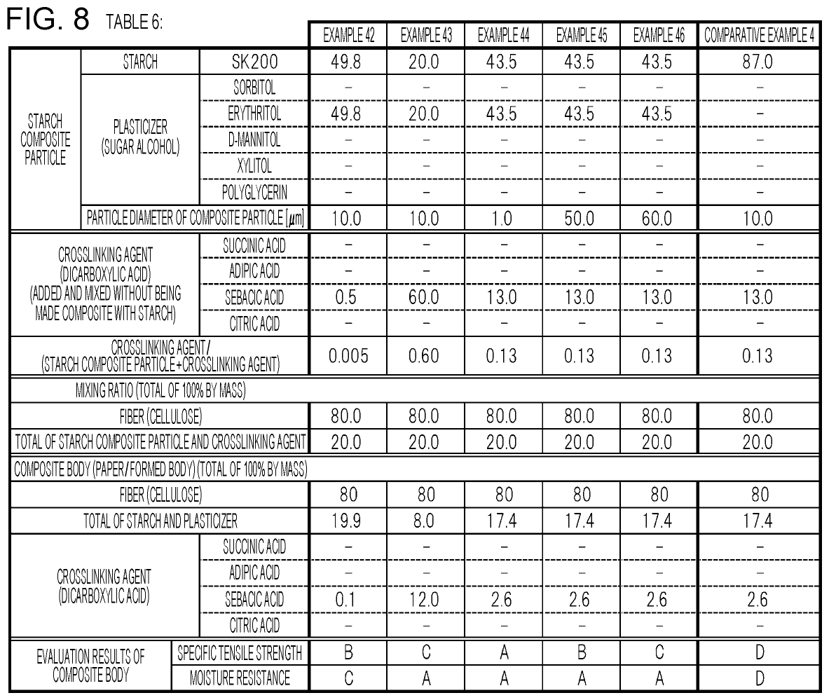

The compositions of the resultant starch composite particles are described in FIG. 3 (Table 1) to FIG. 8 (Table 6). The starch composite particles having different ratios of the starch, the plasticizer, and the crosslinking agent were produced by changing the mixing amount of each of the components during production of the starch composite particles.

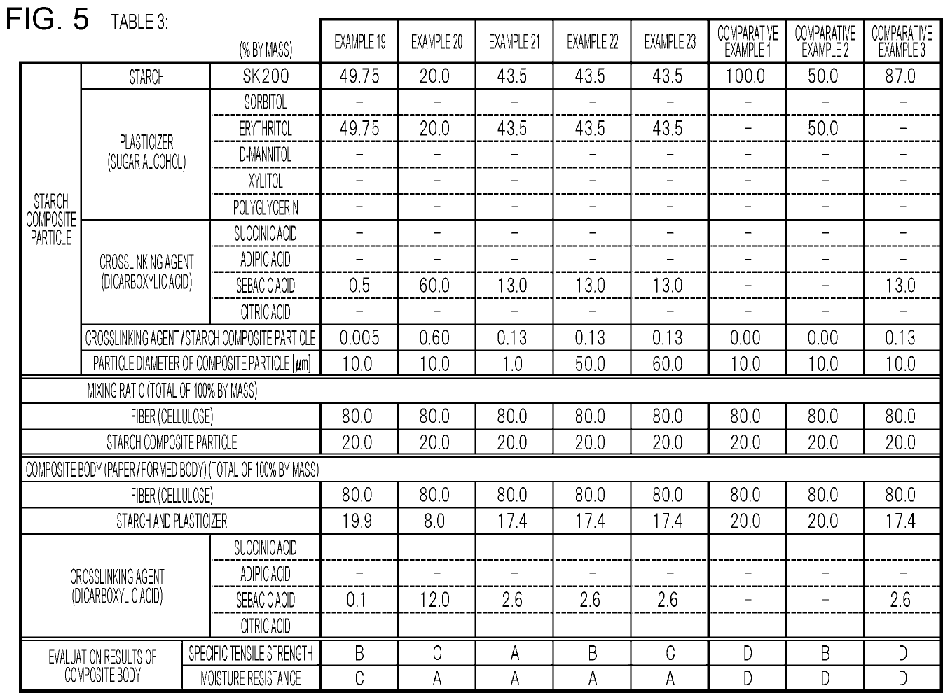

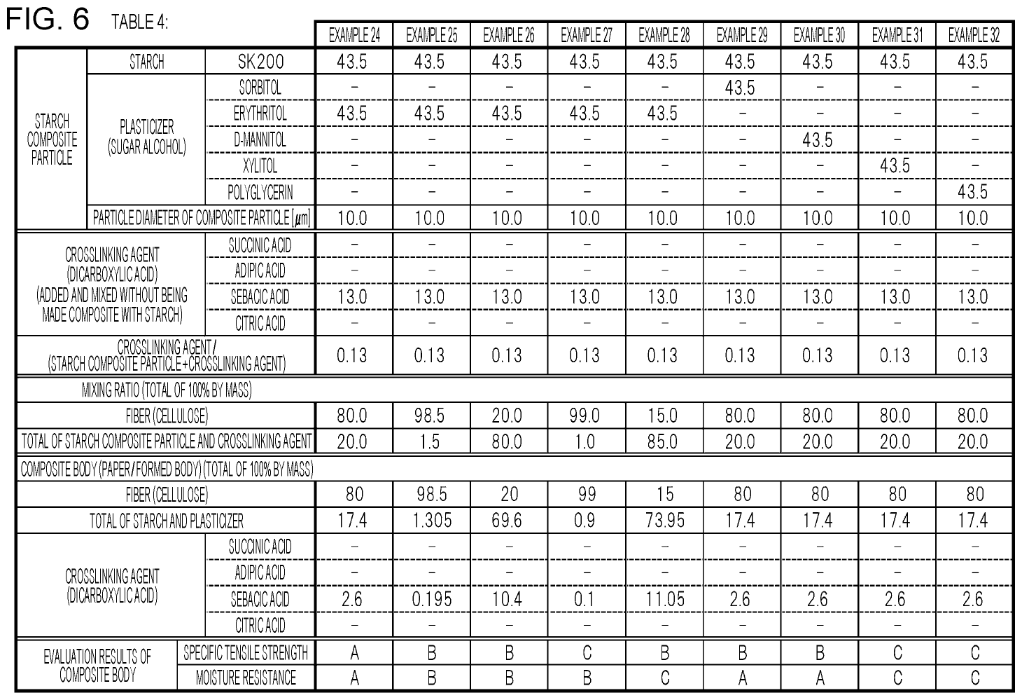

FIG. 3 (Table 1) to FIG. 5 (Table 3) describe the ratio (crosslinking agent/starch composite particles) in the starch composite particles of each of the examples. Also, FIG. 3 (Table 1) to FIG. 8 (Table 6) describe the particle diameters (μm) of the starch composite particles measured by a particle size distribution analyzer (“Microtrac MT3000II” manufactured by Nikkiso Co., Ltd.). In addition, the particles having different particle diameters were formed by adjusting the supply rate of the mixture (gelatinized liquid), the inlet temperature, the outlet temperature, the retention time, the number of atomizer rotations, the atomizing pressure, etc. during spray drying. Further, FIG. 6 (Table 4) to FIG. 8 (Table 6) describe the ratios of the crosslinking agent relative to the starch composite particles.

### 4. 2. Formation of Composite Body

The fibers, the starch composite particles, and the crosslinking agent were mixed so as to obtain the mixing ratios (total of 100& by mass) “total of the fibers (cellulose), the starch composite particles, and the crosslinking agent” described in FIG. 3 (Table 1) to FIG. 8 (Table 6). Several sheets of G-80 (manufactured by Mitsubishi Paper Mills Limited) composed of cellulose fibers were prepared as the fibers (cellulose) using fibers (cellulose) as a raw material. These were housed in the housing portion of the sheet supply portion 10 described above, and the product obtained by operating the composite body producing apparatus 100 was used.

### 4. 2. 1. Formation of Sheet

A sheet was formed as the composite body. A sheet-shaped sample was formed by hot-pressing the mixture of each of the examples at a pressure of 90 MPa and 150° C. for 2 minutes. The sheet was assumed as paper.

### 4. 2. 2. Formation of Sheet

A sheet having a low density was formed as the composite body. A sheet-shaped sample having a low density was formed by hot-pressing the mixture of each of the examples for 6 minutes at a pressure of 1 MPa and 180° C.

The sheet was assumed as a buffer.

### 4. 3. Evaluation Method

### 4. 3. 1. Specific Tensile Strength

The sheet assumed as paper of each of the examples was punched out, specific tensile strength was determined by measurement by using AUTOGRAPH AGC-X 500N (manufactured Shimadzu Corporation) according to JIS P8113 and evaluated according to criteria below. The results are shown in the tables.
A: The specific tensile strength is 15 N·m/g or more.
B: The specific tensile strength is 10 N·m/g or more and less than 15 N·m/g.
C: The specific tensile strength is 5 N·m/g or more and less than 10 N·m/g.
D: The specific tensile strength is less than 5 N·m/g.

### 4. 3. 2. Moisture Resistance

The sheet assumed as a buffer of each of the examples was cut out into a rectangular parallelepiped of 2 cm×1 cm×1 cm. An aluminum plate was placed in a constant-temperature constant-humidity bath, and the rectangular parallelepiped sample was disposed at each of the four corners. Further, an aluminum plate with a weight of 800 g was placed on the samples so as to apply a pressure of 0.01 MPa. The initial gap between the aluminum plate and the aluminum plate was measured, and then the temperature and humidity in the constant-temperature constant-humidity bath were increased to 60° C. and 90% RH, and the gap between the aluminum plate and the aluminum plate was measured after the passage of 120 hours. The ratio of displacement (compression creep rate) from the initial gap was determined and evaluated according to the criteria below. The results are escribed in the tables.
A: The compression creep rate is less than 5%.
B: The compression creep rate is 5% or more and less than 10%.
C: The compression creep rate is 10% or more and less than 20%.
D: The compression creep rate is 20% or more.

### 4. 4. Evaluation Results

It was found that excellent moisture resistance and strength are exhibited by any one of the composite bodies of Examples 1 to 23 in which the composite body contains the starch composite particles, containing the starch, the plasticizer, and the crosslinking agent, and the fibers, and the starch composite particles are dispersed between the fibers, and the composite bodies of Examples 24 to 46 in which the composite body contains the starch composite particles, containing the starch and the plasticizer, the crosslinking agent, and the fibers, and the starch composite particles are dispersed in the fibers.

The embodiments and modified examples described above are examples, and the present disclosure is not limited to these. For example, the embodiments and the modified examples can be properly combined.

The present disclosure includes a configuration substantially the same as the configuration described in the embodiment, for example, a configuration having the same function, method, and results, or a configuration having the same object and effect. Also, the present disclosure includes a configuration in which a portion not essential in the configuration described in the embodiment is replaced. Also, the present disclosure includes a configuration which exhibits the same function and effect as the configuration described in the embodiment or a configuration which can achieve the same object. Further, the present disclosure includes a configuration in which a known technology is added to the configuration described in the embodiment.

Contents below are derived from the embodiments and modified examples described above.

A composite body contains starch composite particles containing starch, a plasticizer, and a crosslinking agent, and fibers, the starch composite particles being dispersed in the fibers.

In the composite body, a plurality of fibers are bound by the starch imparted with thermoplasticity by the plasticizer, and the crosslinking agent forms crosslinking structures between the fibers and the starch, between the fibers, and between the starch and the starch. Therefore, the composite body has excellent moisture resistance and strength.

A composite body contains starch composite particles containing starch and a plasticizer, a crosslinking agent, and fibers, the starch composite particles being dispersed in the fibers.

In the composite body, a plurality of fibers are bound by the starch imparted with thermoplasticity by the plasticizer, and the crosslinking agent forms crosslinking structures between the fibers and the starch, between the fibers, and between the starch and the starch. Therefore, the composite body has excellent moisture resistance and strength.

In the composite body, the total content [% by mass] of the starch, the plasticizer, and the crosslinking agent in the composite body may be 1.5% by mass or more and 80% by mass or less.

The composite body can produce more sufficient strength.

In the composite body, the plasticizer may be one or more selected from sugar alcohols.

The composite body can more easily produce plasticization of the starch. Thus, the composite body can more easily cause binding between the fibers, and can have better strength.

In the composite body, the sugar alcohols may be one or more selected from sorbitol, erythritol, and D-mannitol.

The composite body can more easily produce plasticization of the starch. Thus, the composite body can more easily cause binding between the fibers, and can have better strength.

In the composite body, when the total content of the plasticizer and the starch is 100% by mass, the content [% by mass] of the plasticizer may be 10% by mass or more and 80% by mass or less.

The composite body produces more satisfactory plasticization of the starch, and can have better strength.

In the composite body, the crosslinking agent may be one or more selected from carboxylic acids.

In the composite body, chemical crosslinks between the fibers and the starch, between the fibers, and between the starch and the starch are formed by ester bonds, and thus strength and moisture resistance can be more improved.

In the composite body, the dicarboxylic acids may be one or more selected from succinic acid, adipic acid, and sebacic acid.

In the composite body, chemical crosslinks between the fibers and the starch, between the fibers, and between the starch and the starch are formed by ester bonds, and thus strength and moisture resistance can be more improved.

In the composite body, the content [% by mass] of the crosslinking agent in the starch composite particles may be 1% by mass or more and 50% by mass or less.

In the composite body, the degree of chemical crosslinks between the fibers and the starch, between the fibers, and between the starch and the starch is more improved, and thus strength and moisture resistance are more excellent.

In the composite body, when the total content of the starch composite particles and the crosslinking agent is 100% by mass, the content [% by mass] of the crosslinking agent may be 1% by mass or more and 50% by mass or less.

In the composite body, the degree of chemical crosslinks between the fibers and the starch, between the fibers, and between the starch and the starch is more improved, and thus strength and moisture resistance are more excellent.

In the composite body, the average particle diameter {μm} of the starch composite particles may be 1 μm or more and 50 μm or less.

In the composite body, the dispersion state of the starch composite particles between the fibers is made more uniform, and thus moisture resistance and strength are more excellent.

In the composite body, the fibers may contain cellulose.

In the composite body, crosslinking is more easily produced by the crosslinking agent, and thus strength is more improved. Also, the composite body can further decrease a petroleum-derived component.

In the composite body, the composite body may also be a buffer.

The composite body easily maintains a buffer effect even in a high-humidity environment.

What is claimed is:

1. A composite body comprising:
starch composite particles containing starch, a plasticizer, and a crosslinking agent; and fibers, wherein
the starch composite particles are dispersed between the fibers.

2. A composite body comprising:
starch composite particles containing starch and a plasticizer;
a crosslinking agent; and
fibers, wherein
the starch composite particles are dispersed between the fibers.

3. The composite body according to claim 1, wherein the total content [% by mass] of the starch, the plasticizer, and the crosslinking agent in the composite body is 1.5% by mass or more and 80% by mass or less.

4. The composite body according to claim 1, wherein the plasticizer is one or more selected from sugar alcohols.

5. The composite body according to claim 4, wherein the sugar alcohols are one or more selected from sorbitol, erythritol, and D-mannitol.

6. The composite body according to claim 1, wherein when the total content of the plasticizer and the starch is 100% by mass, the content [% by mass] of the plasticizer is 10% by mass or more and 80% by mass or less.

7. the composite body according to claim 1, wherein the crosslinking agent is one or more selected from carboxylic acids.

8. The composite body according to claim 7, wherein the dicarboxylic acids are one or more selected from succinic acid, adipic acid, and sebacic acid.

9. The composite body according to claim 1, wherein the content [% by mass] of the crosslinking agent in the starch composite particles is 1% by mass or more and 50% by mass or less.

10. The composite body according to claim 2, when the total content of the starch composite particles and the crosslinking agent is 100% by mass, the content [% by mass] of the crosslinking agent is 1% by mass or more and 50% by mass or less.

11. The composite body according to claim 1, wherein the average particle diameter [μm] of the starch composite particles is 1 μm or more and 50 μm or less.

12. The composite body according to claim 1, wherein the fibers contain cellulose.

13. The composite body according to claim 1, wherein the composite body is a buffer.
